(19) United States
(12) Patent Application Publication
(10) Pub. No.: US 2006/0008338 A1
(43) Pub. Date: Jan. 12, 2006

(54) Plate nut connector system without nut holder for inserting the nut into the struts from the front surface direction of the strut

(76) Inventors: Kwang Jin Oh, Fullerton, CA (US); Loren Oh, Fullerton, CA (US)

Correspondence Address: PARK & SUTTON LLP, 3255 WILSHIRE BLVD, SUITE 1110, LOS ANGELES, CA, 90010, US

(21) Appl. No.: 11/208,981

(22) Filed: Aug. 22, 2005

Related U.S. Application Data
(63) Continuation-in-part of application No. 10/884,567, filed on Jul. 6, 2004, now abandoned.

(51) Int. Cl. F16B 39/04

(52) U.S. Cl. 411/87

(57) ABSTRACT

A plate nut connector system includes first strut and second struts, a plate nut, two or more nut holes of different sizes, and two or more bolts corresponding to the nut holes. Each of the first and second struts includes two side walls, a bottom wall, and one or more oval shaped holes on the bottom wall. The plate nut connector connects the first and second struts by screwing the bolts from the outer surface of the bottom wall of the struts, through the bottom wall of the struts, into the nut holes on the plate nut, and the plate nut is adapted to be inserted into the groove perpendicularly to the longitudinal direction of the struts from the front side. The nut holes of the same size are used selectively. The groove formed by the two side walls and the bottom wall is adapted to contain wires or pipes.

### RELATED APPLICATION

This application is a continuation-in-part application of U.S. patent application Ser. No. 10/884,567, filed on Jul. 6, 2004, the disclosure of which is incorporated by reference as if fully set forth herein.

### BACKGROUND OF THE INVENTION

The present invention relates to a plate nut connector system without nut holder for inserting the nut into the struts from the front surface direction of the strut.

More particularly, this invention relates to a plate nut connector system without nut holder, which enables for the struts to hold wires and ducts in a groove formed in the struts.

In order to connect the struts, the workers on electric construction sites should perform time consuming and complicated jobs. The procedure for the job includes the steps of 1) positioning the strut support plate having two bolt holes on the rear face of a connecting point of the two struts, 2) inserting the bolts to the strut support through the washers, 3) mounting the washers on the bolts from the insides of the struts, and 4) engaging the nuts to the bolts and fasten the nuts. Due to the limited space on the inside of the structure of the struts, however, it is not easy to hold the nuts, normally half an inch in size, to fasten them from the inside of the strut. Additionally, the total thickness of the accessories (thickness of the bolt head, plus the thickness of a washer, plus the thickness of a support plate) easily reach over the gap between the strut's rear surface and the bottom of the metal tubing, which contains electric wires that come out from a four switch junction box and are sustained by tube hangers. Workers should bend the metal tubing to make it turn around the connection points. It costs additional time and effort. Not only time, but the number of parts in the prior method is nine and fifteen for the two holes and four connections respectively. However, the number of parts has decreased to five and nine according to the present invention.

Accordingly, a need for a plate nut connector system has been present for a long time considering the wide range of the application. This invention is directed to solve these problems and satisfy the long-felt need.

### SUMMARY OF THE INVENTION

The present invention contrives to solve the disadvantages of the prior art.

An objective of the invention is to provide a plate nut connector system, which connects two strut-like members conveniently.

Another objective of the invention is to provide a plate nut connector system, which enables the plate nut can be inserted from the front.

Still another objective of the invention is to provide a plate nut connector system, which enables to choose proper nut holes from many holes of different sizes.

A plate nut connector system includes a first strut, a second strut, a plate nut, two or more nut holes of different sizes through the hole-bearing surfaces of the plate nut, and two or more bolts corresponding to the nut holes.

The plate nut includes hole-bearing surfaces and plank surfaces connecting the hole-bearing surfaces.

Each of the first and second struts includes two side walls, a bottom wall, and one or more oval shaped holes on the bottom wall. Each of the side walls includes an inner surface and an outer surface. The bottom wall connects the two side walls to form a groove, and the bottom wall includes an inner surface and an outer surface.

The plate nut connector connects the first and second struts by screwing the bolts from the outer surface of the bottom wall of the struts, through the bottom wall of the struts, into the nut holes on the plate nut, and the plate nut is adapted to be inserted into the groove perpendicularly to the longitudinal direction of the struts from the front side. The nut holes of the same size are used selectively. The groove formed by the two side walls and the bottom wall is adapted to contain wires or pipes.

The plate nut is fitted inside the groove with a predetermined margin.

The cross-section of the plate nut is adapted for inserting the plate nut into the longitudinal groove of the struts from the front. The cross-section of the plate nut includes a trapezoid and rectangle.

The length of the plate nut depends on the number of the nut holes on the plate nut. The plate nut is preferably flat. The plate nut is ten (10) millimeters thick, and the plate nut is seven (7) to fifteen (15) centimeters long. The width of the plate nut is narrower than the gap between the inner surfaces of the side walls by a predetermined value. The predetermined value is from about zero point one (0.1) millimeters to about zero point three (0.3) millimeters. The nut hole has a diameter from about one point five (1.5) to about one point nine (1.9) centimeters.

The plate nut includes four (4) nut holes.

The plate nut connector system further includes two or more washer for tightening the bolts.

The plate nut is adapted to the groove formed by the bottom wall and the side walls. The side wall of the strut includes a flange along the brim the groove, and the flanges on both sides face inwardly.

The plate nut is bent along the mid-line between the nut holes on the hole-bearing surface of the plate nut by a predetermined angle. The predetermined angle is from about twenty five (25) to about one hundred fifty five (155) degrees.

The plate nut is bent along the mid-line on the plank surfaces of the plate nut by a predetermined angle. The predetermined angle is from about twenty five (25) to about one hundred fifty five (155) degrees. The plate nut is from about eight (8) to about twelve (12) millimeters thick, the length of each bent wing from about eight (8) to about twelve (12) centimeters, and the width of each bend wing approximately two (2) millimeters shorter than the gap between the two side walls of the struts. The nut hole has a diameter from about one point five (1.5) to about one point nine (1.9) centimeters.

The advantages of the present invention are: (1) the plate nut connector system is convenient to use in a cramped space; (2) the plate nut connector system enables to connect the struts suitable to accept wires and ducts; (3) the plate nut connector system is convenient to use appropriate nut holes selectively from nut holes of different sizes.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is an expanded perspective view showing the connection method of the two struts with a plate metal nut according to the present invention;

FIG. 2 is a front view of the assembled struts and metal plate nut according to the present invention;

FIG. 3 is a rear view of the assembled struts and metal plate nut;

FIG. 4 is a cross-sectional view of the assembled struts and metal plate nut along the line IV-IV in FIG. 2;

FIG. 5 is a schematic cross-sectional drawing along IV-IV showing engaging a plate nut to a strut from the front side of the strut;

FIG. 6 is a cross-sectional view of the assembled struts and metal plate nut along the line VI-VI in FIG. 2;

FIG. 7 is an expanded perspective view showing the connection method of two struts with another embodiment of a plate metal nut according to the present invention;

FIG. 8 is a plane view of the third embodiment of the plate nut according to the present invention; and

FIG. 9 is a plan view of a plate nut with nut holes of different sizes.

### DETAILED DESCRIPTION OF THE INVENTION

The U.S. patent application Ser. No. 10/884,567 is incorporated by reference into this disclosure as if fully set forth herein.

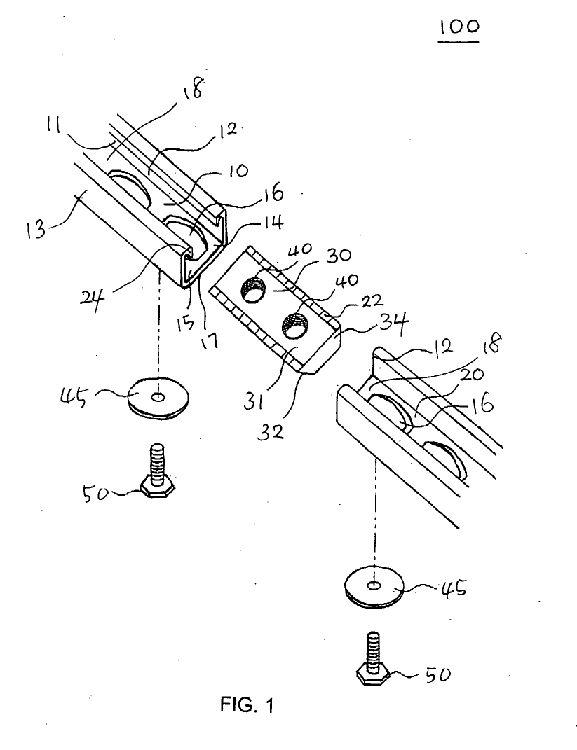

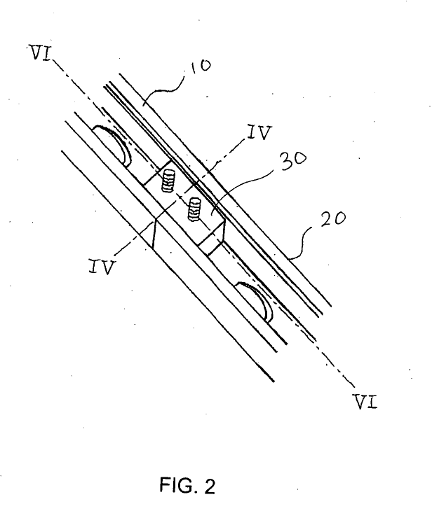

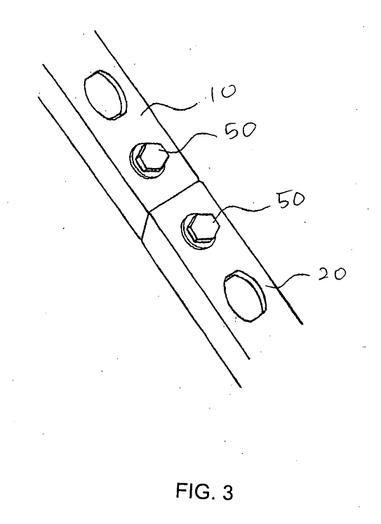

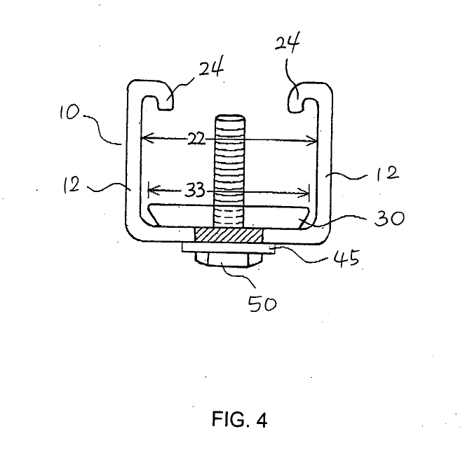

FIG. 1 shows an expanded perspective view showing the plate nut connector system 100 connecting the two struts 10, 20 with a plate metal nut 30 according to the present invention as shown in FIG. 2, FIG. 3, and FIG. 4.

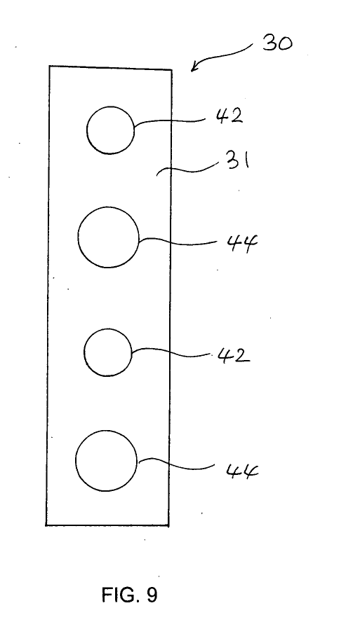

A plate nut connector system 100 includes a first strut 10, a second strut 20, a plate nut 30, two or more nut holes 40 of different sizes (refer to FIG. 9) through hole-bearing surfaces 31 of the plate nut 30, and two or more bolts 50 corresponding to the nut holes 40.

The plate nut 30 includes hole-bearing surfaces 31 and plank surfaces 32 connecting the hole-bearing surfaces 31.

Each of the first and second struts 10, 20 includes two side walls 12, a bottom wall 14, and one or more oval shaped holes 16 on the bottom wall 14. Each of the side walls 12 includes an inner surface 11 and an outer surface 13. The bottom wall 14 connects the two side walls 12 to form a groove 18, and the bottom wall 14 includes an inner surface 15 and an outer surface 17.

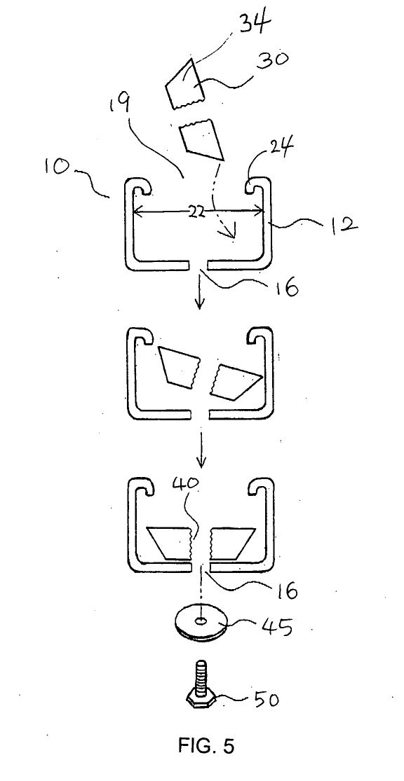

The plate nut connector system 100 connects the first and second struts 10, 20 by screwing the bolts 50 from the outer surface 17 of the bottom wall 14 of the struts 10, 20, through the bottom wall 14 of the struts 10, 20, into the nut holes 40 on the plate nut 30, and the plate nut 30 is adapted to be inserted into the groove 18 perpendicularly to the longitudinal direction of the struts 10, 20 from the front side 19 as shown in FIG. 5. The nut holes 40 (42 or 44 in FIG. 9) of the same size are used selectively. The groove 18 formed by the two side walls 12 and the bottom wall 14 is adapted to contain wires or pipes.

The plate nut 30 is fitted inside the groove 18 with a predetermined margin.

The cross-section 34 of the plate nut 30 is adapted for inserting the plate nut 30 into the longitudinal groove 18 of the struts 10, 20 from the front 19. The cross-section 34 of the plate nut 30 includes a trapezoid and rectangle.

The length of the plate nut 30 depends on the number of the nut holes 40 on the plate nut 30. The plate nut 30 is preferably flat. The plate nut 30 is ten (10) millimeters thick, and the plate nut 30 is seven (7) to fifteen (15) centimeters long. The width 33 of the plate nut 30 is narrower than the gap 22 between the inner surfaces 11 of the side walls 12 by a predetermined value as shown in FIG. 4. The predetermined value is from about zero point one (0.1) millimeters to about zero point three (0.3) millimeters. The nut hole 40 has a diameter from about one point five (1.5) to about one point nine (1.9) centimeters.

The plate nut 30 includes four (4) nut holes 40.

The plate nut connector system 100 further includes two or more washer 45 for tightening the bolts 50.

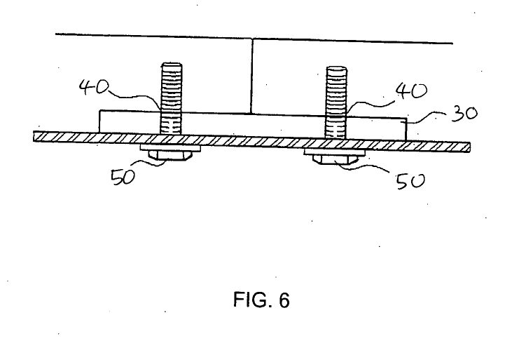

The plate nut 30 is adapted to the groove 18 formed by the bottom wall 14 and the side walls 12. The side wall 12 of the strut 10, 20 includes a flange 24 along the brim the groove 18, and the flanges 24 on both sides face inwardly as shown in FIG. 4 and FIG. 6.

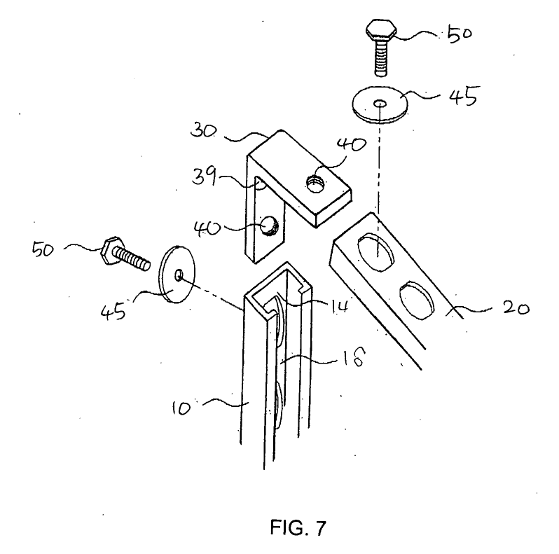

In the second embodiment of the invention as shown in FIG. 7, the plate nut 30 is bent along the mid-line between the nut holes 40 on the hole-bearing surface 31 of the plate nut 30 by a predetermined angle 39. The predetermined angle 39 is from about twenty five (25) to about one hundred fifty five (155) degrees.

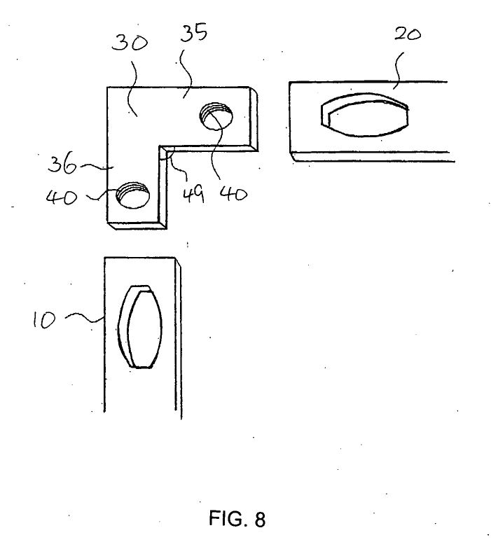

In a third embodiment of the invention as shown in FIG. 8, the plate nut 30 is bent along the mid-line on the plank surfaces 32 of the plate nut 30 by a predetermined angle 49. The predetermined angle 49 is from about twenty five (25) to about one hundred fifty five (155) degrees. The plate nut 30 is from about eight (8) to about twelve (12) millimeters thick, the length of each bent wing 35, 36 from about eight (8) to about twelve (12) centimeters, and the width of each bend wing 35, 36 approximately two (2) millimeters shorter than the gap 22 between the two side walls 12 of the struts 10, 20. The nut hole 30 has a diameter from about one point five (1.5) to about one point nine (1.9) centimeters.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A plate nut connector system comprising:
a) a first strut;
b) a second strut;
c) a plate nut comprising hole-bearing surfaces and plank surfaces connecting the hole-bearing surfaces;
d) two or more nut holes of different sizes through the hole-bearing surfaces of the plate nut; and
e) two or more bolts corresponding to the nut holes, wherein each of the first and second struts comprises
1) two side walls, wherein each of the side walls comprises an inner surface and an outer surface,
2) a bottom wall connecting the two side walls to form a groove, wherein the bottom wall comprises an inner surface and an outer surface, and 3) one or more oval shaped holes on the bottom wall,
wherein the plate nut connector connects the first and second struts by screwing the bolts from the outer surface of the bottom wall of the struts, through the bottom wall of the struts, into the nut holes on the plate nut, wherein the plate nut is adapted to be inserted into the groove perpendicularly to the longitudinal direction of the struts from the front side, wherein the nut holes of the same size are used selectively, wherein the groove formed by the two side walls and the bottom wall is adapted to contain wires or pipes.

2. The plate nut connector system of claim 1, wherein the plate nut is fitted inside the groove with a predetermined margin.

3. The plate nut connector system of claim 1, wherein the cross-section of the plate nut is adapted for inserting the plate nut into the longitudinal groove of the struts from the front.

4. The plate nut connector system of claim 3, wherein the cross-section of the plate nut comprises a trapezoid and rectangle.

5. The plate nut connector system of claim 1, wherein the length of the plate nut depends on the number of the nut holes on the plate nut.

6. The plate nut connector system of claim 1, wherein the plate nut is flat.

7. The plate nut connector system of claim 6, wherein the plate nut is ten (10) millimeters thick, wherein the plate nut is seven (7) to fifteen (15) centimeters long.

8. The plate nut connector system of claim 6, wherein the width of the plate nut is narrower than the gap between the inner surfaces of the side walls by a predetermined value.

9. The plate nut connector system of claim 8, wherein the predetermined value is from about zero point one (0.1) millimeters to about zero point three (0.3) millimeters.

10. The plate nut connector system of claim 6, wherein the nut hole has a diameter from about one point five (1.5) to about one point nine (1.9) centimeters.

11. The plate nut connector system of claim 1, wherein the plate nut comprises four (4) nut holes.

12. The plate nut connector system of claim 1, further comprising two or more washer for tightening the bolts.

13. The plate nut connector system of claim 1, wherein the plate nut is adapted to the groove formed by the bottom wall and the side walls, wherein the side wall of the strut comprises a flange along the brim the groove, wherein the flanges on both sides face inwardly.

14. The plate nut connector system of claim 1, wherein the plate nut is bent along the mid-line between the nut holes on the hole-bearing surface of the plate nut by a predetermined angle.

15. The plate nut connector system of claim 14, wherein the predetermined angle is from about twenty five (25) to about one hundred fifty five (155) degrees.

16. The plate nut connector system of claim 1, wherein the plate nut is bent along the mid-line on the plank surfaces of the plate nut by a predetermined angle.

17. The plate nut connector system of claim 16, wherein the predetermined angle is from about twenty five (25) to about one hundred fifty five (155) degrees.

18. The plate nut connector system of claim 16, wherein the plate nut is from about eight (8) to about twelve (12) millimeters thick, wherein the length of each bent wing is from about eight (8) to about twelve (12) centimeters, wherein the width of each bend wing is approximately two (2) millimeters shorter than the gap between the two side walls of the struts, wherein the nut hole has a diameter from about one point five (1.5) to about one point nine (1.9) centimeters.
